(19) United States
(12) Patent Application Publication
(10) Pub. No.: US 2010/0010934 A1
(43) Pub. Date: Jan. 14, 2010

(54) UNIVERSAL ADVERTISING DIRECTORY

(75) Inventors: David Barry, Mill Valley, CA (US); Slim Chourou, Davis, CA (US); Andrew Fister, III, Champaign, IL (US); Jessica Greenwalt, Berkeley, CA (US); Eric Marutian, San Fransico, CA (US); Leo Veynberg, San Fransico, CA (US)

Correspondence Address: KOPPEL, PATRICK ,HEYBL & DAWSON, PLC, 2815 TOWNSGATE ROAD, SUITE 215, WESTLAKE VILLAGE, CA, 91361-5827, US

(73) Assignee: PRICEARC INC., San Fransico, CA (US)

(21) Appl. No.: 12/500,048

(22) Filed: Jul. 9, 2009

Related U.S. Application Data
(60) Provisional application No. 61/079,390, filed on Jul. 9, 2008.

(51) Int. Cl. G06Q 30/00

(52) U.S. Cl. 705/80

(57) ABSTRACT

This invention relates generally to software, and more specifically, to systems and methods to establish a directory of any kind of offer, whether commercial or non-commercial. The invention enables any person to create a forum for any kind of offer without the intervention or action of the operator of the directory, permitting the directory to be extended to offer types not even understood by the operators of the directory. The invention further enables persons making offers of every type to advertise their offers in such directory, and to rapidly update their offers as market conditions change. The invention further enables consumers to review offers in such directories, and compare offers based on price, years of experience, and other quantified metrics. The invention further enables consumers to invite those making a particular type of offer to bid on a specific job, and for such bids to be organized in charts, maps, and lists from which the consumer can compare the prices and qualifications of those bidding. The invention further enables a reward system providing incentives to people who induce those making offers to list their offers on such directory.

### PRIORITY CLAIM

This application claims the benefit of U.S. provisional patent application Ser. No. 61/079,390 filed Jul. 9, 2008 (our ref. PARC-1-1001). The foregoing application is incorporated by reference in its entirety as if fully set forth herein.

### FIELD OF THE INVENTION

This invention relates generally to methods to create online directories of offers, to join such directories, and to utilize such directories to find and compare those making offers based on objective criteria, such as price and years of experience.

### BACKGROUND

The 1998 to 2008 decade witnessed remarkable innovations, changes, and growth within the internet and computer fields. Google launched in 1998. In the July 1998 issue of PC Magazine the median advertised entry level computer had an Intel 233 MHz processor with 32 Megabytes of RAM. It came with a 3.2 gigabyte hard drive and a 56 kilobit modem. The median internet hosting program charged $30 per month for 30 megabytes of online storage and 3 gigabytes of monthly data transfer.

Exactly ten years later, the July 2008 issue of PC Magazine reviewed entry level laptops whose median specs were an Intel Core 2 Duo processor at an effective clock cycle 3.3 gigahertz (doubling the base rate of 1.67 gigahertz to allow for two processors), 2 gigabytes of RAM and a 160 gigabyte hard drive. There were several types of ports available, and consumers had a variety of connection speeds to choose from. A recent survey reported that an average cable connection speed to be 4.8 megabits per second. For $419 per month a firm could get an enterprise level web site hosted with 1 terabyte of online storage and 5 terabytes of monthly data transfer.

By the end of this decade, CPUs were 14 times faster, hard drives 50 times larger, RAM sizes 63 times larger, and internet connection speeds 86 times faster. In 2008, a dollar would buy 119 times more data transfer from a web hosting site than in 1998. Tellingly, PC Magazine's monthly pages published dropped about 75%.

Despite such dramatic increases in data storage and computer processing, advertising directories have actually become more expensive and not much more functional than those from a decade earlier. Current directories are each independently built using proprietary software and database architecture and, as such, each require independent posting of advertisements. For instance, an advertiser must post a different advertisement in each of YELLOWPAGES.COM, CRAIGSLIST.COM, YELLOWBOOK.COM, SUPERPAGES.COM, DEXKNOWS.COM, YP.COM, and the many other directories in order to broadly target consumers. This problem has been exacerbated by the trend towards more specific directories such as MONSTER.COM, REALTOR.COM, LAWYER.COM, DOCTORDIRECTORY.COM, DENTISTDIRECTORY.COM, and MATCH.COM which provide directories for jobs, homes, lawyers, doctors, dentists, and people, respectively. The combination of general and specific directories is overwhelming and expensive for advertisers and the situation isn't any better from the consumer perspective either. The vast number of directories actually reduces their efficacy through information overload. There are search engine directories, a slew of yellow page type directories, a host of white page type directories, free directories, paid directories, industry specific directories, general directories, and geographic directories. To further complicate matters, each of these directories has unique internet locations, formats, search parameters, and even advertisement listings. Indeed, the situation is so dire that consumers and advertisers alike must consult a directory of directories to help manage the information.

The independent nature of current directories is also tremendously expensive for advertisers and consumers alike. Each directory wastefully duplicates the software architecture of other directories, which expense is passed along to advertisers in the form of higher advertising fees and, ultimately, to consumers in the form of higher product and service prices. For instance, REALTOR.COM obtains its home listings from about 900 multiple listing services. Each home listing on REALTOR.COM averages 85,000 bytes for photos and less than 1,000 bytes for data. With around 4 million resale, new, and rental property listings and about 8.5 million unique visitors each month viewing an average of ten listings, the total data and data transfer amounts are around 414 gigabytes and 146 terabytes per month, respectively. This translates to around $150,000 per year in hosting costs, which is only a half a percent of REALTOR.COM's annual revenue. As another example, aggregated yellow pages listings take up 4.4 gigabytes with an average of 232 bytes per listing. With an estimated 3.8 billion online searches, hosting costs are less than a tenth of a percent of annual yellow page revenues of $16.4 billion. Further, the average job listing on MONSTER.COM is 3,529 bytes. Estimating conservatively, the amount of data transfer is around 10 terabytes a month when 25% of the total US unemployed population of 8.1 million people consults MONSTER.COM daily and spends an average of 12 minutes pulling job listings at 4 per minute. This translates to around $10,000 per year in hosting costs, which is less than a tenth of a percent of MONSTER.COM's annual revenues of $840 million. With such relatively small hosting expenses, it is surprising to learn that REALTOR.COM operates at a loss and has done so for most of its existence. Further, most of the yellow page directory profits arise from print versions of directories and MONSTER.COM made just an 11% profit in 2007. Quite clearly, the reason for such an apparent anomaly is that the bulk of directory expenses are due to building and sustaining wastefully duplicated software architectures. The high cost of current directories occurs because they are built as single-purpose advertising sites. Each directory must pass the costs of software development, operations, security, accounting, sales, and overhead to advertisers. The cycle repeats for every new type of directory.

In addition to the confusion and expense, current directories suffer from even more problems. First, directories listings are limited to the traditional fields such as business name, address, and phone number. Additional information such as current offers, prices, and experience levels are not provided or searchable. Second, directory listings are organized under generic pre-defined headings, such as “real estate agents,” “plumbers,” etc. Thus, consumers must search through these headings and the incomplete listings contained therein before laboriously contacting a series of firms to find the one that best fits their needs.

In short, despite advances in data storage and computer processing power over the last decade that have reduced data hosting costs to practically nothing, advertisers are charged thousands of times more than cost to appear in internet directories, consumers have trouble finding useful listing information, and directory companies are struggling to remain in existence. Accordingly, although desirable results have been achieved, there exists much room for improvement. What is needed then are systems and methods for an improved advertising directory.

An offer-oriented directory is highly desirable in today's economy. An example illustrates the point. If a person wanted pizza for dinner, they would readily find pizza restaurants in current directories. But many non-pizza restaurants also serve pizza, and so do many bakeries and other retail food venues. A person would not know if they could find pizza at the non-pizza food outlets without making a time-consuming search. Thus, consumers would have more choices if they could consult a directory of offers of local pizza. Just as important, food venues not specializing in pizza would benefit by being able to advertise their offers of pizza side-by-side with more overt pizza providers.

If the operators of Expedia, the leading travel site offering air travel, hotel and car rentals, arrived one morning to discover the site filled with lawyers, magicians, graphic artists, and apartments, they would probably be surprised, because Expedia is likely hard-wired to allow only air carriers, hotels, and car rental companies to present offers. But many providers would benefit from having their offerings presented in the clean, easy-to-navigate format that Expedia provides, without having to obtain the permission of Expedia, or require new programming to deal with the new offers. The invention described below creates a site where any form of offer may be presented without obtaining the permission of the site operator, and without any programming.

### SUMMARY

This invention relates generally to a software application for constructing a universal directory for anyone making any kind of offer. The software application dispenses with traditional categories as an organizing tool and instead organizes listings based upon offers. Accordingly, the software application provides a universal advertising directory by permitting the creation and display of advertising for any proposed transaction, including offers of jobs, homes for sale, personal offers involving non-financial goals, romantic searches, and business services, without the massive expense of building separate stand-alone applications.

One feature of the invention is the enablement of ‘uncontrolled’ growth of offers, not requiring the approval of any person. While directory construction and maintenance requires substantial skill and expense, the invention permits a site operator to design the system so any person can readily build sets of offers permitting ‘apples-to-apples’ comparisons of advertisers, and any advertiser can easily promote themselves by listing their prices and qualifications with the offers.

### BRIEF DESCRIPTION OF THE DRAWINGS

Embodiments of the present invention are described in detail below with reference to the following drawings:

FIG. 1 is a block diagram of a method for designing a software system to provide an offer directory according to the goals of the site operator, in accordance with an embodiment of the invention;

FIG. 2 is a block diagram of a method of permitting a person to build offers that can function as mini-marketplaces of advertisers making such offers, in accordance with an embodiment of the invention;

FIG. 3 is a block diagram of a method of permitting an advertiser to promote themselves alongside other advertisers making the same offer, in accordance with an embodiment of the invention;

FIG. 4 is a block diagram of a method of providing online directory information to a consumer of the online directory, in accordance with an embodiment of the invention;

FIG. 5 is a screen shot of a bubble chart of advertisers, in this case comparing florists based on delivery charges and years in business, in accordance with an embodiment of the invention;

FIG. 6 is a screen shot of the FIG. 5 florists, this time showing their location on a map whereby hovering over a pin on the map shows that florist's profile information, in accordance with an embodiment of the invention;

FIG. 7 is a screen shot of the FIG. 5 florists on a list with profile details, in accordance with an embodiment of the invention;

FIG. 8 is a variation of FIG. 5, this time showing a popup window showing details of an advertiser's profile when a user hovers their mouse over the bubble on the diagram corresponding to that advertiser, in accordance with an embodiment of the invention;

FIG. 9 is a screen shot of a gallery, which is a collection of one or more charts and/or galleries, in accordance with an embodiment of the invention;

FIG. 10 is a screen shot of a new account creation screen, in accordance with an embodiment of the invention; and

FIG. 11 is a screen shot of a chart builder page, in accordance with an embodiment of the invention.

APPENDIX A is sample code, in accordance with an embodiment of the invention.

### DETAILED DESCRIPTION

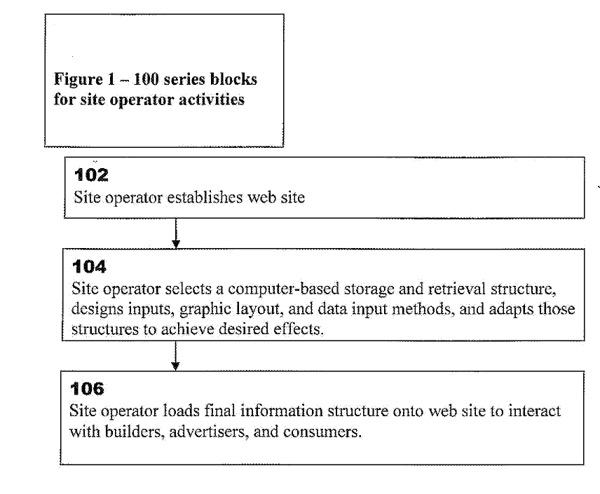

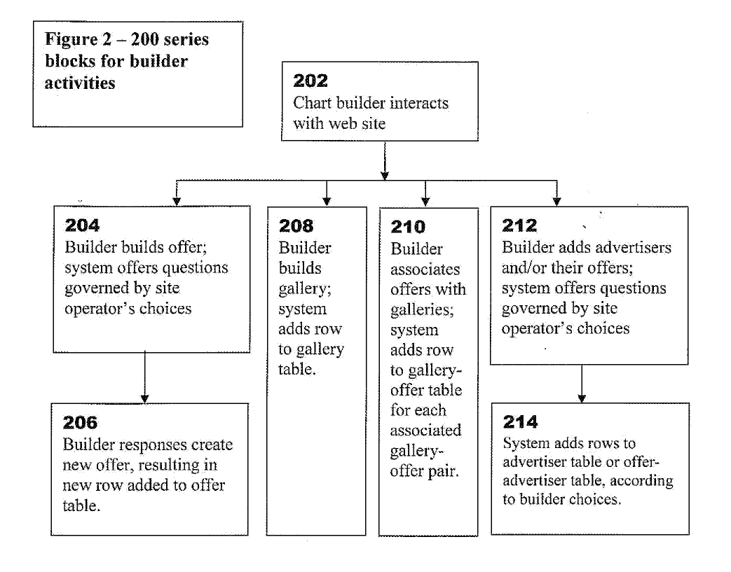

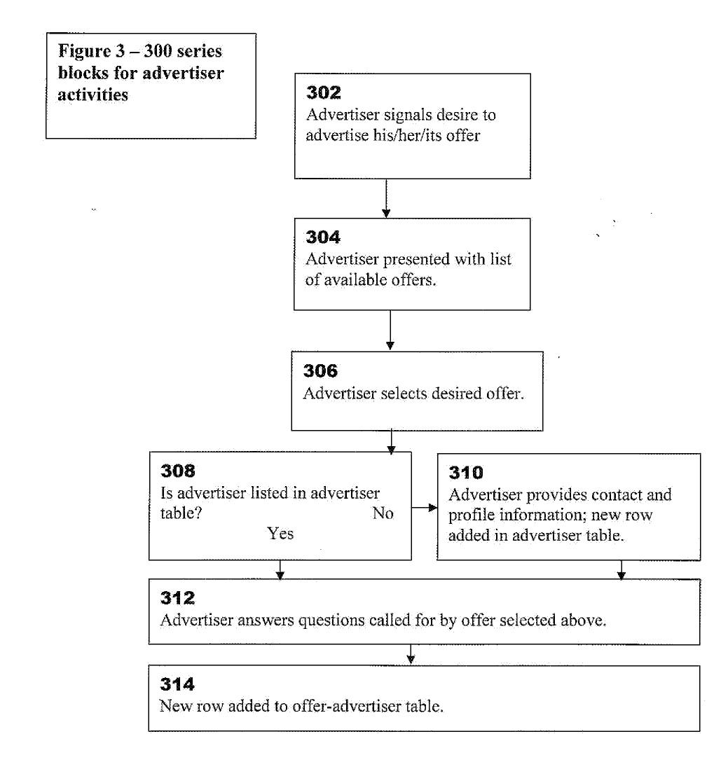

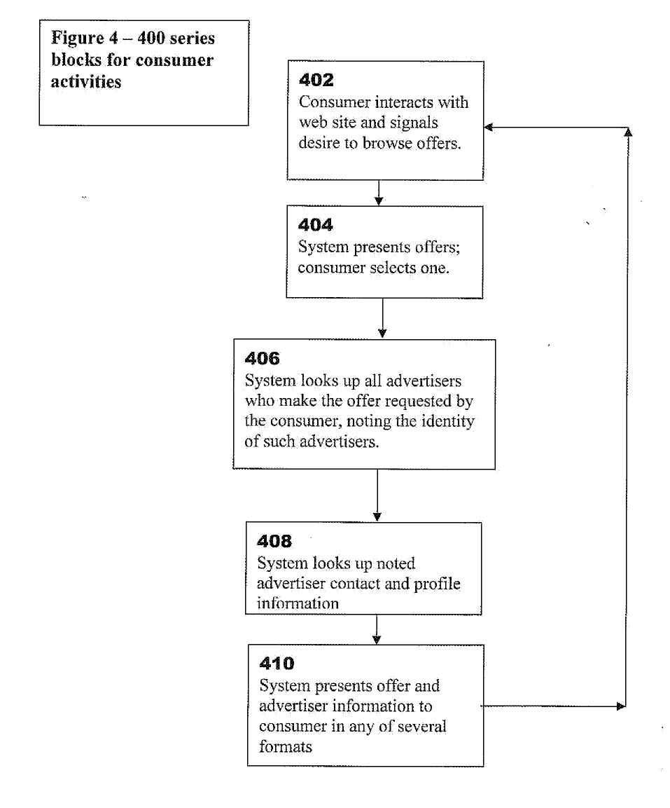

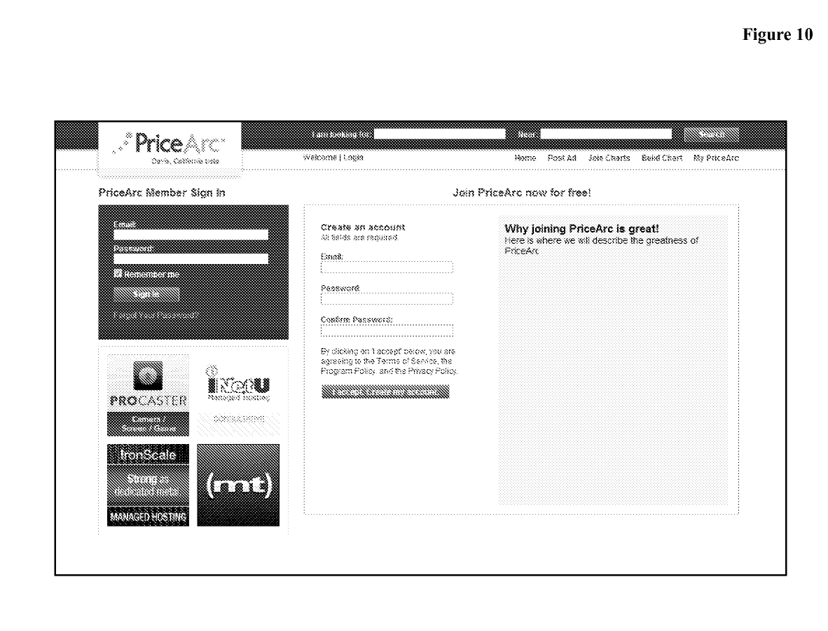

This invention relates generally to the construction, modification, and use of online directories for the purpose of obtaining directory information, advertising commercial and non-commercial offers, and obtaining payment for services provided in building content of the directory. Specific details of several embodiments of the invention are set forth in the following description and in FIGS. 1-11 and APPENDIX A to provide a thorough understanding of such embodiments. The present invention may have additional embodiments, may be practiced without one or more of the details described for any particular described embodiment, or may have any detail described for one particular embodiment practiced with any other detail described for another embodiment.

In various embodiments, the invention enables four classes of persons to employ the invention, each with varying powers and privileges. As used here, a site operator has the power to shape possibly every aspect of the installation of the invention on computer systems, and to configure the manipulation of information processed by the resulting directory. When the site operator has completed her work, a universal directory exists on a computer network but does not yet have any offers displayed and contains no advertisers. A builder interacts with the directory to draft offers incorporated into the directory, which will function as mini-marketplaces within the directory where that offer is made by advertisers. Builders may construct offers using screens and prompts constructed by the site operator. To avoid confusion, a completed offer as existing on the directory is often referred to as a chart. Each chart contains only one offer and its possible variants. Advertisers can promote themselves by listing themselves on one or more charts, stating their prices and qualifications. By such listings, advertisers announce they make the offer stated in the chart. If an advertiser has offers to make that do not exist in the directory, the advertiser can assume the role of builder to construct those offers, then list themselves in that new chart.

A consumer is a person who utilizes a device connected to the computer network to view and compare advertisers who make the offers in the directory. A consumer may also interact with advertisers by asking them to bid on a proposed purchase by the consumer.

Embodiment: advertisers with hourly rates. One embodiment permits the display of advertisers who sell their services with hourly rate as the method of pricing, which includes many attorneys, therapists, plumbers, and others. All may be presented with this embodiment by using the following method. Several collections of data are assembled using any means that permits computer-readable fields for separate members of the data assemblies. It is convenient but not necessary to use tables as are conventionally manipulated by databases. These embodiments will use the column and row nomenclature common to databases.

FIG. 1 is a block diagram of a method for designing a directory structure using computer-based table structures to contain information in accordance with various embodiments of the invention. In one embodiment, method 100 includes establishing a website at block 102 which includes configuring a website to be accessible over the internet or other communications network. In certain embodiments, the website is dedicated to advertising, whereas in others it is combined with other functionality such as providing information, selling goods, offering services, or searching. The website may be independently owned and operated, a partnership website, or a combination of the two. The website is accessible via any display medium such as a personal computer, mobile phone, or personal digital assistant. The website may contain a plurality of pages.

In one particular embodiment, the application can use three tables to achieve its function. The first table can be an ‘advertiser table’, with column headings for a unique advertiserID, advertiser name, and one or more other columns for contact information, URLs of advertiser web sites, and laudatory information about the advertiser. Each row of this table can hold a separate advertiser. The second table can be an ‘offer table’, with at least two columns, one for a unique offerID and the other for the offer, consisting of a word, phrase, or sentence comprising the offer. Each row of the offer table can contain a separate offer, but not necessarily a substantially different offer. The third table can be an ‘offer-advertiser table’, with at least four columns with column headings consisting of offer-advertiserID (the column to hold unique ID numbers), offer (to hold offerIDs from the offer table), advertiser (to hold advdertiserIDs from the advertiser table), and hourly rate (to hold the numerical hourly rates charged by the advertisers. The choices on table structures can be made by the site operator at block 104 and may be different from those set forth in the examples above. Once completed, the site operator may load the three tables to the web site at block 106 and display the completed directory structure to the public.

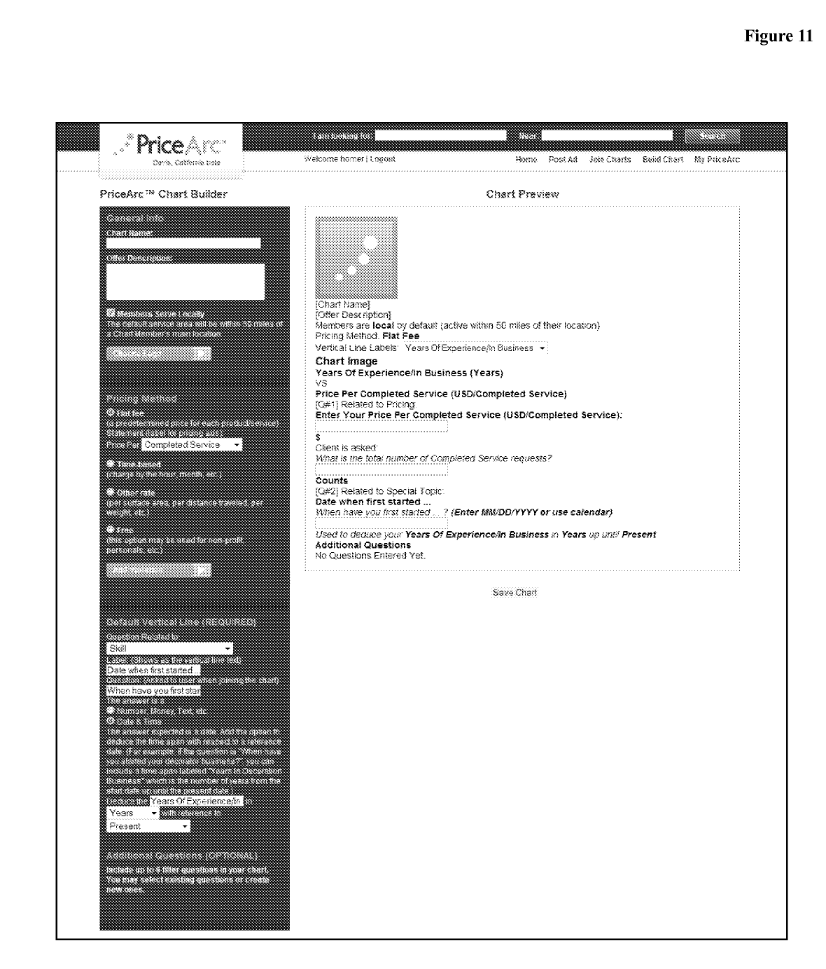

A builder can interact with the directory at block 202 to construct an offer. For example, a trade association of lawyers, desiring to assist its members to advertise, could respond to system prompts at block 204 [such as those shown in the screen shots at FIG. 11 to list many offers of its members, such as ‘Corporate advice’, ‘Defend first offense drunk driving charge,’ and ‘Write wills for two spouses’. Upon doing so, the system adds a new row to the offer table at block 206 for each offer. Likewise, a manufacturer of guitars could interact with the system at block 202 to create a chart called ‘Guitar instruction’ at block 204, upon which the system creates a new row in the offer table with the entry ‘Guitar instruction.’

In one embodiment, a lawyer desiring to advertise on the directory interacts with the web site directory at block 302, and inquires what charts are available through a convenient means such as a drop down menu presenting all rows in the offer table in block 304. The lawyer selects the ‘Write wills for two spouses’ offer at block 306. The system checks to see if the lawyer is already in the advertiser table at block 308. If so, the system asks the advertiser the hourly rate question created by the builder at block 204. Upon receiving an answer from the lawyer and checking for validity (i.e., a numeric quantity), the system adds a new row to the offer-advertiser table at block 314, the row consisting of a unique offer-advertiser ID, the offerID for ‘Write wills for two spouses’, the lawyer's advertiserID, and the lawyer's hourly rate. If the lawyer is not in the advertiser table at block 308, the system provides the lawyer prompts at block 310 calling for the lawyer's name, contact information, and other fields. Upon receiving the requested information, a new row is added to the advertiser table at block 312, the row containing a unique row ID and the information given by the lawyer. If desired, the lawyer could return to block 304 to see other available charts, and select the ‘Guitar instruction’ offer, in the event the lawyer also offered guitar instruction. Upon selecting ‘Guitar instruction’ at block 306, the system, knowing from the previous step that the lawyer is already in the advertiser table, asks the lawyer his/her hourly rate for guitar instruction at block 312, and upon receiving an answer, creates a new row in the offer-advertiser table at block 316, consisting of a new row ID, the offerID for Guitar instruction, the lawyer's advertiserID, and the lawyer's hourly rate for guitar instruction.

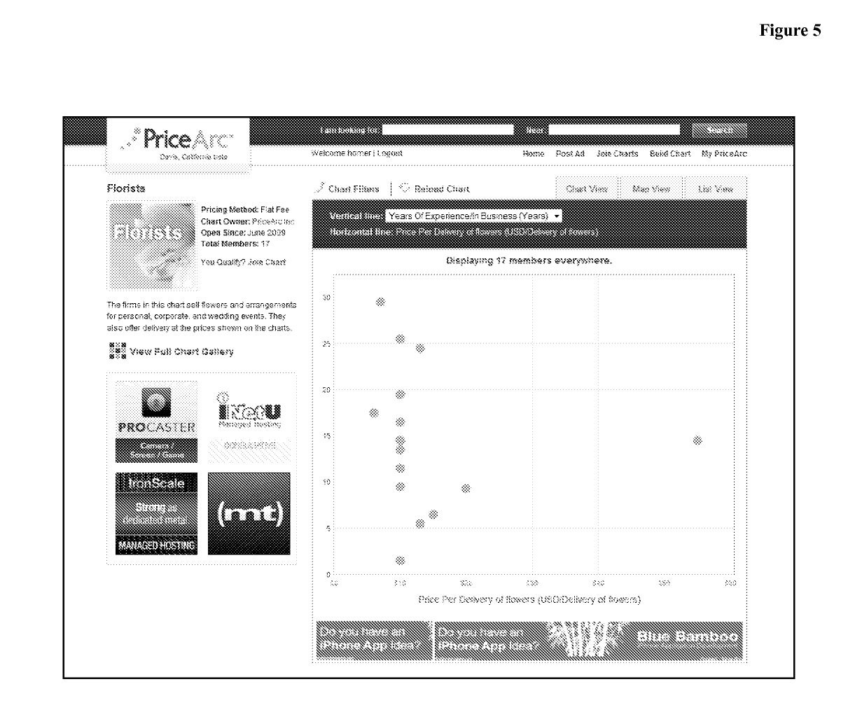

In one embodiment, a consumer looking for guitar instruction interacts with the site at block 402 and requests available offers. Offers are presented at block 404, and the consumer selects the ‘Guitar instruction’ offer. The system selects all rows in the offer-advertiser table where the value for offer=‘Guitar instruction’ at block 406, and notes the identities of the advertisers found on those rows. Using the look-up feature of the system at block 408, the system uses the advertisers' identities to find all advertiser information in the advertiser table, presenting the offer and advertiser information to the consumer at block 410, as shown FIGS. 5-7. The first of these illustrations shows the chart view of advertisers (florists, in this case). The second shows the same providers on a map. The third shows the advertisers in a list with profile information. When finished browsing the advertisers making this offer, the consumer can return to block 402 to choose to browse advertisers making other offers.

Embodiment: multiple profiles. One embodiment enables advertisers to use multiple profiles. For example, the lawyer offering guitar instruction in the hourly rate embodiment might want to have one profile for potential law clients and a different profile for guitar instruction clients. This embodiment can be achieved with a profile table with profileId as primary key, a second column for advertiserID, and additional columns organizing advertiser information into columns for such things as education, licensing, laudatory descriptive material, and contact information. The offer-advertiser table of the hourly rate embodiment can be adapted to add a column with heading ‘profileID’. After selecting the desired offer to list with at block 306, the system can present the active profiles for the advertiser, and the advertiser can select the profile to present to consumers. Upon selecting a profile, the system will add a new row to the offer-advertiser table containing the information from the hourly rate embodiment, plus the advertiser's selected profileId in the profileID column. Advertisers can build profiles at block 310 iteratively, each profile creating separate rows in the profile table.

When a consumer selects an offer at block 404, the system looks up the advertisers making the offer at block 406, and looks up the contact and profile information at block 408, presenting it at block 410.

Embodiment: years experience. One embodiment enables advertisers to promote themselves with their years of experience. To do so, the site operator adds another column to the offer-advertiser table with a heading such as ‘start date’ at block 104. An advertiser is prompted at block 312 for additional information, such as through a text box asking a question such as ‘How many years have you offered this service?’. The advertiser fills in a number such as ‘17’, meaning the advertiser has 17 years' experience providing the service. After validating the response for numerical answers, the system stores the information in one of several ways, conveniently subtracting 17 years from the system date, storing the result in date format in the ‘start date’ field of the offer-advertiser table, along other information collected. If, one year later, a consumer asks for guitar instructors at block 404, the consumer receives personal information on guitar instructors, including the information that the advertiser just referenced has provided guitar instruction for 18 years, a figure derived by subtracting the ‘first started’ date from the current system date.

Embodiment: accomplishments. Years of experience might not tell the entire story, since some providers may perform a service many times a year, while others do so irregularly. To present a yet fuller picture to users, the site operator could allow builders to collect and present information on how many times the advertiser had performed the service offered. The site operator might anticipate that the directory could usefully collect and present data on how many trials a lawyer had conducted and how many students a guitar instructor had taught. Since the site operator does not know what offers builders will post on the directory, the site operator does not necessarily hard-wire lawyer-specific or instructor-specific questions, but can instead construct a method for builders to collect and present accomplishment metrics relevant to specific offers. The site operator can do so at block 104 by creating two new fields in the offer table with headings such as ‘question to elicit accomplishment’ and ‘label for accomplishment’. The site operator can also construct prompts directing builders to draft such questions and labels. The offer-advertiser table can also be augmented with a column and heading such as ‘accomplishment’. After the builder provides the requested information at block, a new row is added to the offer table containing the accomplishment question and label. When an advertiser provides requested information at block 312, a new row is added to the offer-advertiser table including the accomplishment metric. When consumers view advertiser information at block 410, they can see the experience metric provided by the builder. For instance, in the screen shot at FIG. 5, the accomplishment label states “Years of experience/in business (Years)” in the text box at the top of the illustration. The function of this label is to explain the meaning of the y-axis numbers.

In various embodiments, a screen shot shown to a builder at block 204 is presented at FIG. 11. A feature of this embodiment is that consumers can toggle the accomplishment axis shown on the y-axis between years experience and number of trials conducted, in the case of a lawyer's offer.

Embodiment: four pricing methods. Realizing many advertisers do not charge based on an hourly rate, the site operator can structure the directory system to be flexible enough to handle advertisers making offers on other than hourly rates. In one embodiment, the site operator has structured the system to handle four pricing methods: flat fee; a rate per some unit of time (seconds, minutes, hours, 50-minute therapy sessions, etc); a rate per some unit other than time; and free. These decisions and design work are implemented at block 104. In this embodiment, flat fee rates and free offers can be encoded in a single field and rates based on time or non-time units can be encoded in two fields. These fields can be stored in the offer table, one field for type of pricing (flat fee, free, time rate and non-time rate), and the second field for the unit required, if time based or non-time based.

When a builder creates a new offer, the system can ask at an appropriate step what pricing method is used by advertisers making this offer. In one embodiment, the question is asked at block 204. A screen shot including one such a question is shown at FIG. 11. If a time-based rate or non-time based rate, the system can also ask for the units involved, and the question to elicit pricing information. A screen shot calling for this information is shown at FIG. 11.

In one embodiment, when an advertiser selects the desired chart at block 306, the system reads the row in the offer table corresponding to the offer selected, and notes the builder responses for pricing method, pricing units, and question phrasing, according to pricing type. If ‘flat’, the builder's question could be something such as ‘What do you charge for a 12 inch pizza?’ If time-based, the system could ask something such as ‘What do you charge per year for anti-virus protection?’ If non-time-based, the system could ask something such as ‘What do you charge per square foot for re-painting the interior of an apartment?’ If the offer does not require financial compensation, the system skips the pricing question. The advertiser answer to the pricing question can be stored in the new row of the offer-advertiser tables in a single column called something like ‘pricing value’.

Embodiment: Variations on offer. In one embodiment, several offers may be collected and processed as a group. An example of the convenience of such a method occurs in the case of limousines, which come in different sizes, such as 4-passenger, 6-passenger, 8-passenger, etc. Other examples include related services by service providers, but the method need not be confined to related services or products. A site operator desiring such a method can make an election to do so in block 104 by, for instance, creating a new field in the offer table indicating the maximum number of variations permitted with a heading such as ‘maximum offer variations’. When a builder creates an offer at block 204, the system prompts the builder whether another variation is desired, and if so, the builder repeats the block 204 process iteratively as long as the number of offer variations does not exceed the number of maximum offer variations set by the site operator. If the builder builds more than one variation, the system can encapsulate all variations in the same data structure through the use of appropriate punctuation symbols. As an example, where the builder elects to create three varying offers based on three massage durations, the three questions eliciting pricing variations could be encoded in square brackets, and separated by semi-colons. Likewise, when the advertiser answers questions related to the offer at block 312, the system presents three questions iteratively, and all answers can be stored using the same punctuation scheme in the offer-advertiser table in the ‘pricing value’ column. By use of this method, builders have the discretion to build separate offers, or cluster the offers as variations to suit their goals.

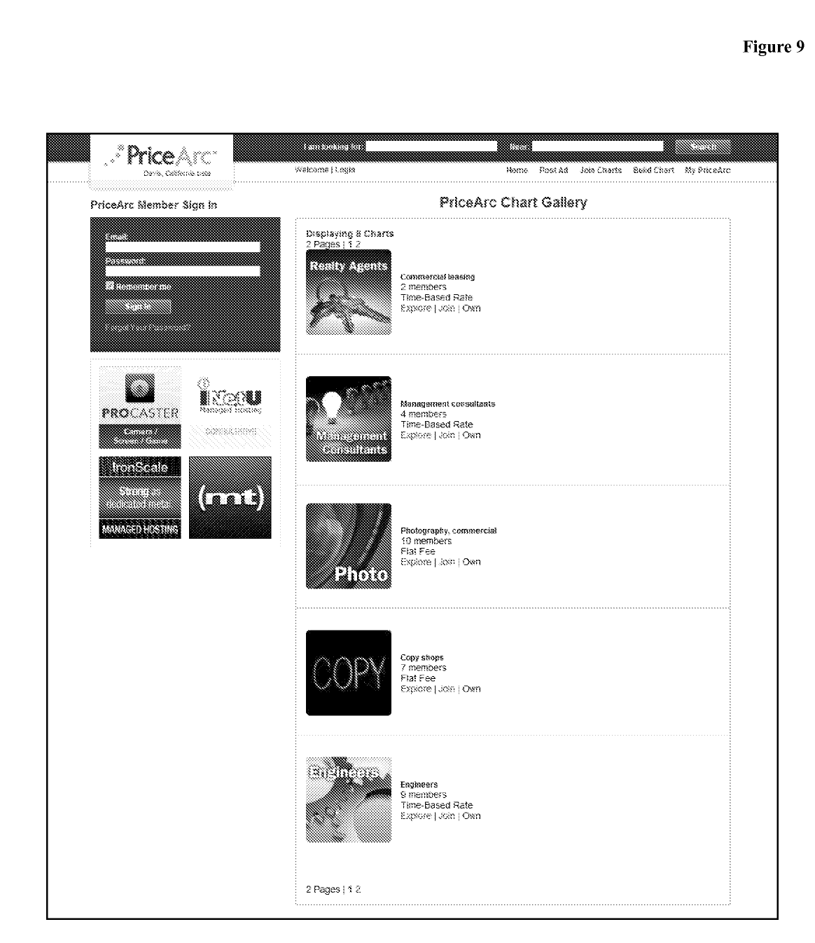

Embodiment: Galleries. In one embodiment, offers may be grouped together for presentation to users; such groups may be called galleries or any other convenient word or phrase. A screen shot of a gallery of offers is shown at FIG. 9. A site operator may create a gallery option at block 104 by creating a gallery table consisting of three columns (galleryID, gallery name, offerID) and a gallery-offer table (galleryID, offerID). The site operator can create prompts to instruct the builder to input a gallery name to an input device. In addition, the site operator can create prompts and an input method to prompt the builder to associate an offer with a gallery. A builder desiring to create a gallery may do so at block 208 by responding to site operator-created prompts. A builder desiring to associate one or more offers with a gallery may do so at block 210 by responding to site operator-created prompts. The creation of a new gallery adds a row to the gallery table. The association of an offer with a gallery creates a new row in the gallery-offer table. By using the same method, galleries can contain galleries, thus enabling a hierarchical organization of all offers in the directory. Because builders may associate any offers they want with any galleries, such hierarchies need not be consistent, and consumers may use the gallery-hierarchies that suit them, resulting in some galleries being more popular/useful than others. Each gallery may carry its own set of statistics on member population and consumer traffic and other useful metrics.

Embodiment: Images. In one embodiment, images may be associated with galleries, offers, advertisers, or other elements of the directory. Examples of logos associated with charts are shown at screen shot FIG. 9. A site operator who desires to permit images associated with elements of the directory may do so at block 104 by creating an image table consisting of three columns, imageID, objected, and ‘object type’, where the object type specifies whether the associated object is a gallery, offer, advertiser, or other object. The site operator can also create a prompt to prompt a user to create or upload an image. A builder can create, upload, or associate an image associated with an offer at block 204. A builder can create, upload, or associate an image associated with a gallery at block 208. An advertiser can create, upload, or associate an image associated with themselves at block 310.

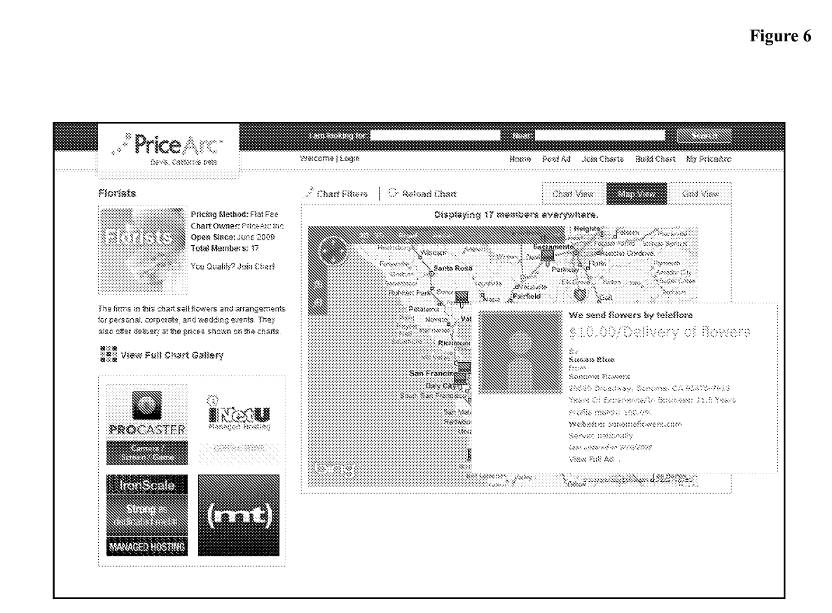

Embodiment: Geographic performance area. In one embodiment, each advertiser may state the region in which they offer to perform. A site operator may obtain this function at bock 104 in a variety of ways. One convenient method consists of adding a column to the offer table named ‘radius’ and adding a column to offer-advertiser table, also called ‘radius’. By suitable means the site operator crafts prompts and input methods inviting the builder to state the typical radius for persons making the offer being built. For example, the radius for most barbers is zero, since customers usually must travel to barber shops. Dog walkers might have a typical radius of 10 miles. U.S. patent lawyers might have a global radius, meaning they can apply for a U.S. patent for a client anywhere on the globe. A screen shot of coverage indication is shown at FIG. 6, in the popup window, with a florist providing nationally. The radius provided by the builder at block 204 can be stored in the ‘radius’ field of the offer table as ‘global’ if global, or a numeric value in miles or other suitable distance units if the offer is typically less than global. The site operator can also craft prompts and input methods inviting the advertiser to state at block 312 the radius around their location, as stated by the advertiser at block 310, where they make their offer available. The radius stated by the builder can act as a default. If the advertiser answers the radius question at block 312, it may be stored in the ‘radius’ field of the offer-advertiser table, and can override the default stated by the builder.

Embodiment: Geographic meeting area. It is one thing for a graphic site operator to state they can deliver graphic design globally, but quite another to be available for a face-to-face meeting anywhere in the world. In one embodiment, each advertiser may state the region in which they are willing to travel for a face-to-face meeting without a travel allowance. This embodiment can be achieved by the same method as the geographic performance area embodiment, with the difference being the names of the columns and the prompts utilized by the site operator to elicit the information.

Embodiment: Keyword search. In one embodiment, a consumer indicates their desired offer at block 402 by entering alphanumeric requests in a suitable search input device created by the site operator at block 104. A screen shot of this method is shown at the top of FIG. 5. By conventional means the consumer's input may be used to search words and phrases appearing in offers and/or questions created by builders at block 204, gallery names created at block 208, and/or advertiser text created at blocks 310 and/or 312. Offers and/or galleries containing such keywords, or lexically similar to such keywords, may be presented to the consumer based on conventional linguistic measures of closeness-of-fit, in the discretion of the site operator.

Embodiment: Geographical search. In one embodiment, the system is able to present geographically relevant search results to consumers. In addition to desired offers, a consumer indicates their desired geographic delivery area at block 402 by entering a geographic location and radius in a suitable search input device created by the site operator at block 104. The system intersects the two radii by using commercially available intersection methods. For instance, if the consumer desires realty agents within 25 miles of Oakland, Calif., and realty agents have advertised their availability within 40 miles of Sacramento, Calif., standard geographic intersection packages will determine that the Oakland consumer is beyond the range of the Sacramento agent. As a consequence, the Sacramento agents will not be presented. The system will present agents whose service delivery area intersects the requested delivery area of the consumer.

Embodiment: Languages. In one embodiment, advertisers may publish the languages they can communicate in. When an advertiser provides contact and profile information at block 310 the advertiser may indicate all languages they can communicate in. This function can be achieved by more than one method. One convenient method is to create a table of world languages, or a suitable number of top world languages, and present these languages to the advertiser in a drop-down list. By suitable means the advertiser is requested to select the languages they can communicate in. The language IDs of the languages used by the advertiser may be encoded in a single ‘language’ field of the advertiser table with suitable delimiter punctuation separating the language IDs.

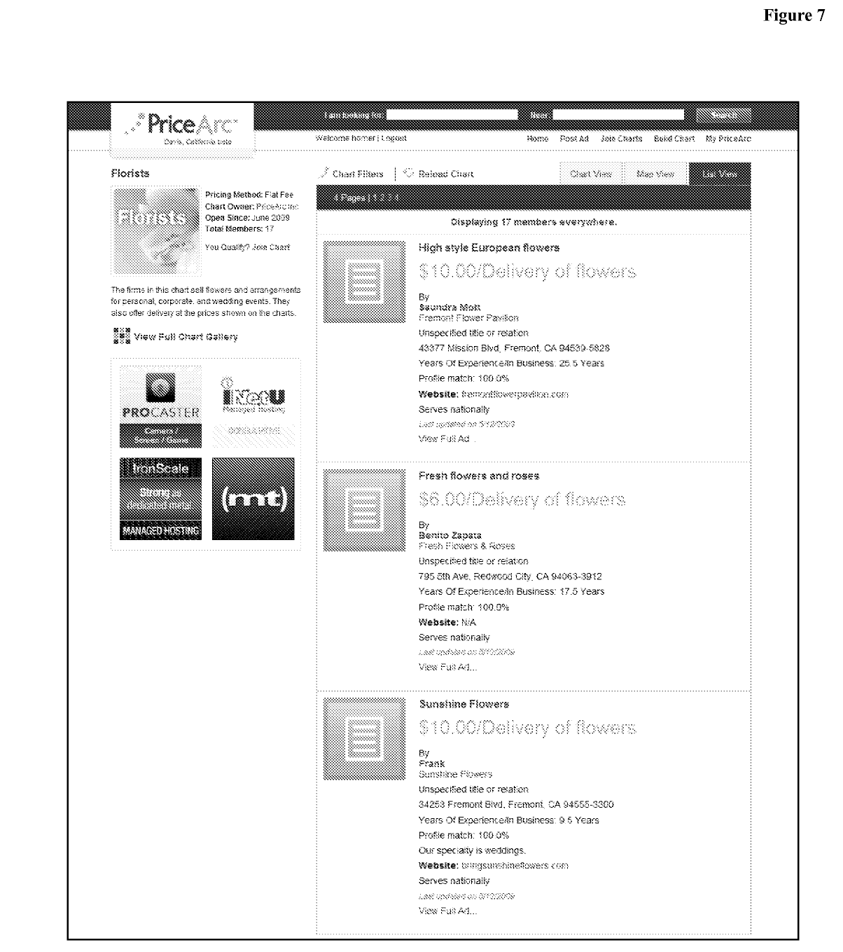

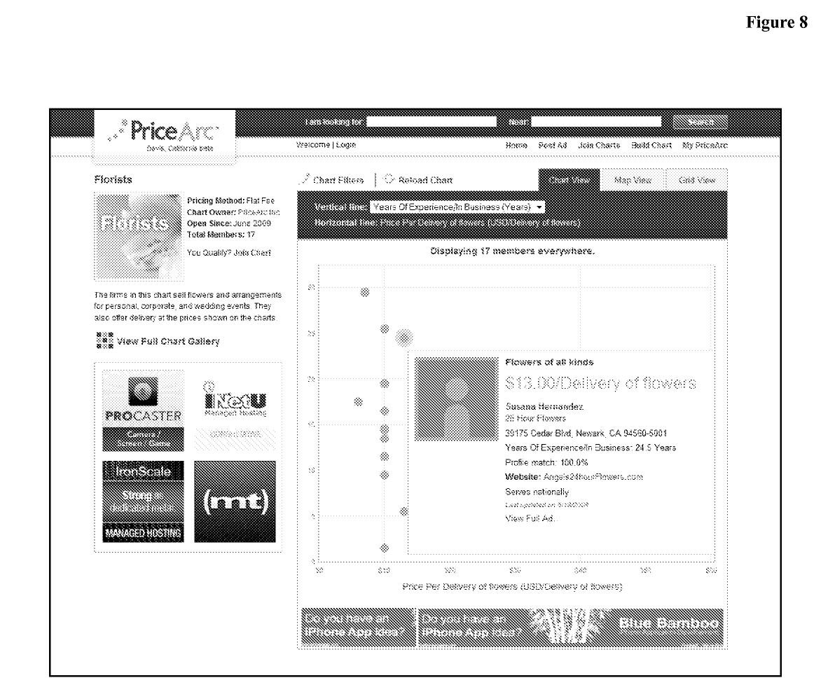

Embodiment: Data presentation of advertisers. In an alternative embodiment, when a consumer searches for a particular offer, the primary page displayed for that offer is summary data in the form of a graphical representation of price versus years of experience for all advertisers listed thereunder. A screen shot of this method is shown at FIG. 5. Accordingly, the software application permits advertisers to be first displayed irrespective of their respective size, experience, or financial backing. As a result, small or unknown advertisers can effectively compete with large, rich, and well-established advertisers without spending more on advertising. Tabs on the display page permit other types of graphic display, including map display as shown at FIG. 6. The icons representing positions of advertisers on the map may be of any form, type, size, color, saturation, transparency, and shape of icons used to provide the summary data is pre-determined by the software application or is custom definable by the site operator, builder, or advertisers. In addition, the map icon may present advertiser content. As an example, the icon may state the price offered. Thus, instead of push-pins shown, the actual price may be stated. A tab on the display page permits other types of graphic display, including a list display such as shown at FIG. 7. Such lists may be sorted in any order, including lowest price first. On some displays, the system can present ‘mouse-over’ windows showing details of advertisers as users hover their mice or other signaling devices, such as fingers on smart devices, as shown in FIG. 8. The bubble chart presentation embodiment can be achieved by noting the quantified values of price and years of experience for the advertisers making the offer in the offer-advertiser table. Commercially available software modules create scatter diagrams given sets of x-y data points. If the offer invites advertisers to state more than one accomplishment metric, this embodiment allows consumers to choose among several accomplishment metrics by means such as a drop-down menu, and upon selection a new set of y-values is matched with x-values corresponding to price, and the scatter diagram module generates a new scatter diagram. If the offer contains variations, this embodiment allows consumers to select among these by means such as a drop-down menu. Upon selection, a new set of x-values is produced to be matched with previous y-values corresponding to accomplishment, and the scatter diagram module generates a new scatter diagram.

Embodiment: Data presentation of consumer activity on site. In one embodiment, the software application collects consumer behavior on the site, such as click-throughs to advertisers, time spent on respective advertisers and/or offers, and provides summary data for an advertiser, offer, or gallery using charts, lists, graphs, or other visual or tabular data representations. The form, type, size, color, saturation, transparency, and shape of icons used to provide the summary data is pre-determined by the software application or is custom definable by the site operator, builder, or advertisers. For example, icons can be advertiser logos. In this embodiment the relevant metric is click-throughs from dots on the scatter chart to advertiser profiles. Every time a consumer clicks through from a chart dot to the advertiser profile on the site the system can capture relevant data, such as a pair of data values consisting of (1) the unique ID of the row in the offer-advertiser table affected (i.e., the offer the consumer is looking at and the advertiser whose dot was clicked on), and (2) the date-time value on the system clock at the time of the click. This pair of values may be stored in a suitable location, such as a table named a ‘click table’ which could have two columns named something like ‘click’ and ‘time’. On an occasional basis, such as daily, the software application could inventory this table for each offer, and count the number of times consumers clicked on the dots of every advertiser for every offer in the preceding time period, such as 30 days. That per-advertiser trailing-30-day click count could be stored conveniently in the offer-advertiser table in a column named something like ‘30-day click total.’ The system could sum all these 30-day click totals and store the sum in a column in the offer table in a column named something like ‘30-day click total.’ The individual advertisers' 30-day click totals could be divided by the offer's 30-day click total to compute each respective advertiser's percentage of clicks in the preceding 30 days, and this percent could be stored conveniently in the offer-advertiser table in a column named something like ‘30-day click percent.’ The system's graphic display page of offers normally presents all advertiser dots with the same form, size, color, saturation, transparency, and shape. This embodiment uses a method consisting of a ‘heat map’ button or other convenient method for consumers to turn on the display of relative percentages of consumer clicks in the preceding 30 days, and when turned on, the dots with the lowest percentages could be display with cool colors such as blue or green, and those with highest percentages getting, for instance, red. This heat map button could be toggled on and off by consumers, and be persistent across all offers displayed. The heat map button could alter any other aspect of advertiser dots, including form, size, saturation, transparency, or shape. This heat map method could be applied to any other desired consumer activity on the site. In addition, if the offer contained variations as described elsewhere, the click totals and click percentages for the advertisers could be compressed as described in the method for offer variations.

Embodiment: Adapting offers. In one embodiment, builders are able to create new offers by adapting existing ones. A builder seeking to build a new offer may adapt an existing offer at bock 204 by selecting the offer desired to adapt through any convenient means, such as a drop-down list. Once selected, the system can present all builder decision prompts with the response fields pre-filled with the previous responses. The builder can either accept these or edit them, saving the result to a new offer name. In this embodiment, a builder may adapt an existing offer and keep every detail of the existing offer, effectively making a complete duplicate of the adapted offer. In this embodiment, the builder may use any image to associate as a logo with the new offer so long as the builder has the right to use such image. The method is the same for offers with variations.

Embodiment: Adapting galleries. Builders may adapt galleries using the same method as for adapting offers.

Embodiment: Private offers. The default condition for offers is that they are ‘open’, meaning any advertiser making such offer may advertise to promote themselves by listing themselves with the offer by responding to offer prompts. This embodiment permits the opposite condition, an offer for which an advertiser does not have such rights. Such an offer may conveniently be described as ‘private’. Any builder may conveniently create a private offer at block 204 by responding to prompts asking whether the builder wants the offer to be open or private. In this embodiment, the default value is ‘open’. It is convenient to record builder choices using the following method, one of several possible methods. If the builder elects to create a private offer, the system can store such choice in a column in the offer table named something like ‘access’, with the value ‘open’ stored in the field unless the builder chooses ‘private’. If the builder elects a private offer, the builder can then be offered access choices, two possible choices being password access and URL access. If the builder requests password access, then only those using the password may list themselves on the builder's offer. This situation may occur, for instance, with a trade association of, say, home remodelers. Such a trade association may want to promote a national web marketplace where consumers can find home remodelers and compare prices and experience metrics. If the association wants to limit the benefits of the site to its members and prevent freeriding by non-members of the association, it can give its members a password to advertise on the site. If the builder selects URL access, then anyone knowing the URL of the offer may list themselves. This method may be used by persons and firms posting job listings in a newspaper or online sites such as Monster or Craigslist. The ad could provide the details of the job in the usual manner and then list the URL of the offer, asking job applicants to visit the URL to apply for the job. In this embodiment, job seekers clicking the URL, or typing it in their browser from a newspaper ad, visit the site and are treated by the site as potential advertisers able to respond to system responses, with such responses collected and presented as described in other embodiments. Employers thus build offers in this embodiment, and gain the advantage of being able to see applicants' experience metrics presented graphically on a secure site instead of the customary situation of many job applicants' emails cluttering the employer's email box. When building a private chart builders can be given data display options as ‘public’, meaning having the offer and all advertisers and their pricing and profile information full viewable by the public (an option many trade associations may elect, as described at the start of this embodiment), or ‘private’, meaning having the advertiser prompts and data collection devices viewable by potential advertisers but not permitting such potential advertisers to see the data display of responses of prior advertisers (an option many employers may select), or ‘semi-public’, meaning same as private data display option with prior advertiser responses visible on a data display, but with no identifying information or advertiser profiles. The semi-public data display option may be popular in a bidding mode, when a firm seeks prices on a specification, and wants to know the pattern of bids.

Embodiment: Site-to-user notices. In one embodiment, the site operator can communicate with possibly all advertisers, builders, or other users of the software application. Such notifications can be useful for providing notice of system changes, account status, traffic reports, and other uses described in other embodiments. The site operator can create a button or other suitable mechanism to initiate a notification, and place such button on any convenient site location, such as administration pages. Upon initiation, the system prompts the site administrator to state the criteria defining the recipients of such communication. Upon defining the criteria, the system prompts the administrator to create the message. Upon finalization, the system consults appropriate tables of recipients with a request to select all users who satisfy the criteria, and the system sends the message to the selected set. Such notification can be sent by any means, electronic or otherwise. Such notification methods can be stored and repeated automatically, as with monthly account statements to advertisers.

Embodiment: userIDs. In one embodiment, the system keeps track of all users authorized to use the system by use of a User table, consisting of a column called UserID, and additional columns unique to such users, such as password, date of authorization, name and contact information, and the version of the ‘terms of use’ the user has agreed to. The userID is unique and assigned when the person first registers with the system. In this embodiment, every registered user also receives advertiser privileges and an advertiserID which can be the same as userID.

Embodiment: userID not the same as advertiserID. In an alternate embodiment, some users may not have advertiser privileges. In this embodiment, the advertiser table has an additional column for userID. Only those users with advertiser privileges are entered in the advertiser table.

Embodiment: Privileges. In another embodiment, the system permits users to have different privileges by creating a new table for each privilege. Such table can have a single column, consisting of the system userID. For instance, if only certain users have the privilege to, say, build offers, a builder table would have a table of userIDs with builder privileges. When a user first logs onto the system, the system could consult all privilege tables to see which privileges the user possessed, and store those privileges in session variables. In the case of a user with builder privileges, the session variable might be stored in a session variable called something like vPrivBuilder and set it to ‘true’. If a random user seeks to build a new offer, the system could allow or not allow the build process according to whether vPrivBuilder was true for such user. The use of such privilege session variables permits the frequent use of privileges without delaying performance by frequent look-ups or privilege rights.

Embodiment: Editing empty offers. In one embodiment, a method is described to control editing of offers while there are no advertisers who have made the offer. At the point a builder finalizes an offer and no advertisers have yet made the offer, no one would be affected by a builder's making changes to the offer. In this embodiment, the builder maintains sole control over the offer by means of an entry in the offer table in a column named something like ‘owner’ and a value equal to the builder's userID. If a random user sought to edit that offer, the system would deny editing privileges unless such user's ID matched the ‘owner’ value for the table to be edited.

Embodiment: Builder-loaded advertisers and editing privileges. It may be convenient for a builder who has just constructed an offer to populate the offer with advertisers, with prices and accomplishments, rather than wait for advertisers to do so themselves. For instance, a franchisor of a certain brand of restaurants, or the owner of a chain of realty offices, may want to promote outlets in the chain by including them on relevant charts. This embodiment presents a method for advertisers to ‘take possession’ of their system identities when originally created by others. The method consists of creating two additional columns in the user table: (1) an editor column whose value is the userID of the user with rights to make edits to the profile of the advertiser row, and (2) a password column with a randomly generated password created when the row is created by a user with a userID different than the userID of the row being created. An example using a hypothetical illustrates. Assume Mango is a small, fast-growing restaurant franchisor specializing in inexpensive, healthy lunch and supper meals. Assume when Mango first registers it receives userID Mango888. Mango registers its 100 franchisees, each one receiving a separate row in the user table. Assume the Austin franchise receives userID ‘Austin333’ and randomly generated password ‘jigg7779’. The editor column for Austin333 has the value Mango888 because Mango created it. Mango lists its Austin franchise in several restaurant charts. Mango then invites its franchisees to update their profiles and encourages them to create and populate new charts. Mango can access the unique password in each of the password columns it created, and Mango sends the 100 separate userIDs and passwords to each of its 100 Mango franchisees. The Austin franchise logs on with userID Austin333 and password jigg7779. Upon doing so, the system changes the value in the editor column in the user table for the Austin333 row from Mango888 to Austin333. From that point forward, the Austin franchise has the sole privilege to edit all entries in the user table. Likewise, the method permits Austin333 and no one else to edit other tables granting privileges to Austin333 because the system allows only two users to make such edits: the user referenced by the table and the user with editor rights for such user. Since Austin333 has halted the right of Mango888 to edit its user table entries, it has halted the right of Mango888 to edit any table for which Austin333 has user rights.

Embodiment: Consumer-to-advertiser notices. In one embodiment, consumers can communicate with chart advertisers for questions, prices, or other purposes. A method for performing such communications can conveniently be accomplished through an adaptation of the site-to-user embodiment presented elsewhere. A consumer notice to advertisers on a chart may conveniently be commenced with a ‘ping’ button placed on every chart. Upon activating the button, the site offers the consumer choices as to type of communication requested. In this embodiment, the user selects an option to request an electronic text message to all advertisers. By suitable text input devices, the system collects the text desired by the consumer and the consumer's email for advertiser replies to the communication. By suitable means the consumer indicates the message is ready to be sent, and the system sends the message electronically. This method permits messages to be sent by a variety of means, including email, text message, and micro-blogging, among others. Because of the potential for spam to chart advertisers, the method also includes alternatives as selected by the builder at block 204. At a suitable point in the construction process of an offer, the builder may be offered options for spam control. The builder's choice could be stored in a column in the offer table called something like ‘spam.’ A builder who elected to have consumer communications delivered by way of posting on a periodic bulletin containing consumer notices could have that choice recorded in the ‘spam’ column by a ‘bulletin’ value. Upon the consumer sending a notice to chart advertisers using the ping method, the consumer text and the consumer's email could be stored in a pair of columns in a table called something like ‘bulletin table’, consisting of columns such as offerID, date, time, consumer text, consumer email, and flag. At convenient intervals, such as daily, the system could collect all consumer messages for each offer, convert them to a list, and send the list to offer advertisers using the site-to-user notice method. When a consumer notice was added as a new row in the bulletin table, an electronic notice could be sent to a chart administrator to review the consumer message. If determined to be spam or otherwise in violation of site terms of use, the chart administrator could flag the communication to prevent its routine dispatch by setting the ‘flag’ value for the communication to ‘spam’ or other appropriate value. The delay between when the consumer posted the communication and when the bulletin was dispatched could give time for many spam attempts to be defeated. If an advertiser on a chart wanted immediate notice of consumer communications, the advertiser could signal this election at block 312 by using appropriate input methods to elect to receive consumer notices as received in the bulletin table, or at some other interval. If the advertiser wanted immediate notification, the advertiser's election could be stored in a ‘ping’ column of the offer-advertiser table with a value such as ‘immediate’. When the system received a consumer notice to advertisers on a chart, and the system recorded a new row in the bulletin table, the system could generate a notice of such consumer communication to all affected advertisers who had recorded ‘immediate’ in the ‘ping’ column of the offer-advertiser table by use of the site-to-user method.

Embodiment: Bid requests. In one embodiment, a consumer is able to ask advertisers making an offer to supply new prices for a proposal designed by the consumer. A consumer viewing advertisers making an offer may want a quote on a prospective purchase. For instance a consumer viewing advertisers offering 12-inch pizzas may want a price on a 10-year-old's birthday party on a certain date and time with 50 guests, 25 12-inch pizzas, and soda with a free-refill policy. In this embodiment, the software application provides a method to ‘ping’ all advertisers on the chart requesting a price quote. This function may be accomplished by, for instance, placing a ‘ping’ button on chart pages inviting consumers to request a price quote from advertisers. By doing so, the software application could use the private chart method described in another embodiment, and setting URL access and private data display as defaults. These defaults can be set by the builder at block 204. For instance, a pizza restaurant industry group might build an offer oriented toward pizza restaurants and construct price quote defaults that encourage the public to place price quotes. The price quote of this embodiment can be communicated through the site to chart advertisers upon completion of the creation of the private offer in the offer table. The system could note that a private offer has been created through use of the ‘ping’ button, and initiate a system broadcast of emails to all advertisers in the offer-advertiser table (or the variation thereof).

Embodiment: Freshness pings. Upon pressing a ping button, the site operator may offer consumers a variety of options, such as requesting a price quote, described in another embodiment, or requesting freshness updates. In this embodiment consumers can request chart advertisers to confirm the recency of their prices by pressing a ‘ping’ button that may be included with every chart. Upon pressing the button, the chart re-displays, omitting all advertisers who have not reconfirmed their offers within a preceding period of time which may be determined by, for instance, a value defined by the builder and stored in a column with a name such as ‘reconfirm period’ in the offer table. Advertisers omitted in this refresh operation could receive a notification using the site-to-user notices method that they were excluded from a user's view of a chart because they had not recently reconfirmed the pricing on their offer.

Embodiment: Filters. This embodiment permits advertisers to attach qualifications with non-continuous values to offers, and for consumers to use those qualifications as filters to select which advertisers to examine. While qualifications can usually be used as alternate y-axis metrics, non-continuous values may conveniently used as filters. Such filters can be constructed by the builder at block 204 with one column in the offer table defining the phrase presented to advertisers and consumers, and a second column in the offer table providing the type of filter variable, such as binary or discrete. A third column could provide validation information, such as permitted values for discrete variables. An example of these choices may occur in a rental housing chart. This chart can use the variation method described in another embodiment to present five rental housing unit variations: studios, one-bedrooms, two-bedrooms, three-bedrooms, and four-bedrooms and above. Each of these could have the following binary filters as to policies or features: pets allowed, smoking permitted, pool, recreation room, sauna, tennis, barbeque, basketball, weight room, on-site manager, internet, parking, lease required, secure building, elevator, furnished. Discrete value variables could include: floor (i.e., basement, first floor, second floor, etc). Continuous value features that could be used as y-axis values could include: amount of security deposit, square feet in the unit, distance to closest market, distance to closest public transit line. Discrete value variables could be presented to advertisers in a variety of ways including radio buttons or check boxes, and the same method could be used to present the information to consumers in profile information for each of the advertised units. Builders could also elect to treat some of the discrete variables as discrete value variables. For instance the ‘tennis’ variable could be presented as a discrete value variable integer values representing the number of courts present. A filter button could be present in every chart. When a consumer activated the filter button a popup window could appear presenting all filters available for the chart. In the housing example, the consumer could request the chart to present only apartments allowing pets. In such case the system could select all rows from the relevant table where the binary value of ‘pets’ was ‘true’ or ‘yes’ or any other convention corresponding to a ‘yes’ indication by the advertiser. Alternatively the consumer could request apartments where pets were not allowed, in which case the system could select all rows from the relevant table where the binary value of ‘pets’ was ‘false’ or ‘no’. A consumer could also filter on any y-axis value, such as requesting presentation of only apartments with monthly rents of $1,500 and below. Another embodiment could also request presentation of apartments between a range of y-axis values, such as monthly rental prices. Multiple filters could be activated in any combination. In addition, the geographic position-radius feature at the top of chart represents an independent filter that can act in combination with filters activated with the filter button.

Embodiment: Email loading. In one embodiment a person would have the ability to invite a potential advertiser, or a mailing list of potential advertisers, to list with an existing offer through the use of email without ever interacting with the site. In this embodiment any person could initiate an email to one or more potential advertisers inviting them to list an offer by means of an email to a specified email address. The initiating person could send an email to a potential advertiser requesting information to be provided in a reply email to a recipient email address. The means by which this embodiment can achieve its function is (1) any electronic message receiving structure (which includes but is not limited to email, text messaging, automated phone calling, or micro-blogging device such as twitter), (2) a site hosting the software application, (3) with the ability to receive and parse incoming emails, (4) a pre-existing offer to which the potential advertiser may list with, and (5) a coding and decoding scheme by which the sending party may invite the potential advertiser to use to provide listing information. An example of this embodiment may occur with a trade association of therapists desiring to assist its members to promote themselves by publishing their services. The trade association may have previously built an offer on the software application with a name such as ‘Therapy—anxiety treatment’, selecting a pricing method such as price per 1-hour treatment session. With reference to the elements of this embodiment, the association could (1) send an email (2) containing a subject line to all its members inviting them to answer several questions in a reply email to (3) a specified address such as Listings@SiteHostingSoftwareApplication.com. This site will have a previously established (4) method to parse incoming emails from therapists and other potential advertisers. The site receiving the email may have (5) a pre-existing offer such as ‘Therapy, anxiety treatment’ with a pricing mechanism based on price for a one-hour treatment session, and requiring advertisers to provide price and years experience. By use of (6) a pre-existing coding and decoding scheme, a codec, the association could invite members to answer questions, send the emailed questions to the hosting site. Thus, the email subject line could say ‘Promote your <Therapy, anxiety> practice’, and the association could send it to its members, saying: ‘To get this free listing, copy these questions and provide answers inside the angle brackets so your answers will be read: <My name is: . . . >; <My hourly rate for a therapy session is: . . . >; <I have: . . . years experience>; <My phone number is: . . . >. The codec previously established on the software application is to read only material between the angle brackets, and to strip out material provided by the association, such as ‘My name is:’ and the ellipsis ‘. . . ’. The codec could identify the stripped-out language with similarly worded input prompts and input fields on the site. The codec could associate each email field with a corresponding input field for advertisers, and treat the email answers as inputs to the site input fields, entering new rows in the advertiser and offer-advertiser tables. By this means potential advertisers could list themselves through the convenience of email or other electronic messaging means without having to visit the site.

Embodiment: Site email interrogation. In a related embodiment, the email inquiries of the email loading embodiment could be initiated by the software application site, calling for advertisers and potential advertisers to merely reply. By this means the software application could achieve rapid updating of key fields and inventories. A practical application of this would be chart dealing with offers of hotel rooms available that day. The software application could interrogate hotels at two-hour intervals during the afternoon and early evening, for instance, for updates on number of rooms remaining vacant, with replies containing current inventories immediately posted to the software application site to provide the public with accurate inventories of rooms available at different prices and features. The software application could use the preferred communication channel for each hotel, which could be the hotel desk phone in one case—with the answer communicated by use of the key pad to indicate rooms left—or an email visible on the computer screen of the hotel check-in clerk in another case. Such preferences could be kept in a field of the advertiser table.

Embodiment: Means of compensating builders populating charts. A chart stating an offer with no advertisers presents no value to consumers. It would be desirable to provide incentives to those who place advertiser information into charts. One embodiment presents a method to compensate those who populate charts with advertisers. An example illustrates the utility of this method. Assume an insurance agency called Risk sells malpractice insurance to local lawyers. Assume Risk wants a low cost way to attract the attention of lawyers. Using this embodiment, Risk could become a builder and create a chart for court reporters in the area. The chart shows prices and experience metrics. Using the method described in the embodiment relating to builder-loaded charts, Risk populates the chart with court reporters itself, after making calls and getting their prices and experience. Other insurance agencies in other parts of the country also research local court reporters and load them into the same chart, resulting in a court reporter chart with court reporters all over the United States. In this embodiment, even though Risk created the chart, and is therefore considered a builder, the other insurance agencies also added valuable content to the chart and also became, in the nomenclature of this invention, chart builders. This embodiment provides a way to provide compensation to chart builders who populate the charts by means of a column in the offer-advertiser table which may be called ‘originator’. Assume Risk places 100 advertisers in the court reporter chart, resulting in 100 new rows of the offer-advertiser chart, where the offerID is that of the court reporter offer, and the advertiserIDs are those of the new advertisers in that table. For each of those rows, the value of the originator column would be Risk's builderID. In this and other embodiments, an equivalent functionality could be achieved by using the userID of the builder, and not creating a separate builderID. Providing compensation to builders populating this chart may be achieved by awarding points accumulated on some convenient frequency, such as daily or monthly. Points may be accumulated as follows. On a, say, daily basis the total number of reporters in the court reporter chart could be counted by the system with the total stored in a session variable called varAdvertiserCount. The counting process could also tally how many advertisers were originated by each of the builders represented in the originator column. If the set of builders whose IDs were found in the originator column were the set b₁, b₂, . . . bₙ, then the advertiser count for each builder could be represented by the integer varAdvertiserᵢ, where the subscript i represents builderᵢ in the set of 1 through n builders. The sum of all these advertiser counts, from varAdvertiser₁ through varAdvertiserₙ will add to varAdvertiserCount, by definition. Relative percentages originated by each builder can be computed by dividing varAdvertiserᵢ by varAdvertiserCount for each i, from 1 through n, resulting in a series of percentages varOriginatorPercentᵢ, from 1 through n, one for each of the builders. When rounded to the nearest percent for each one, varOriginatorPointsᵢ each of these values may be treated as integer points varying between 0 and 100, and cumulated in a builder-offer table, with these three columns: builderID, offerID, and DailyPointsCount. In the process just described, n new rows may be added to this table, one for each builder, with the builderID consisting of each of the n builderIDs, the offerID being the one for the court reporter chart, and the points being each of the varOriginatorPointsᵢ recorded for the respective builders. This process may be repeated daily for the month, with the daily points being added to the previous totals. Advertisers may be added during the month and others may disappear, resulting in each builder receiving an accurate number of points reflecting the advertiser's efforts to populate the chart. On the last day of the month the values in the DailyPointsCount column may be moved to a fourth column in the offer-builder table called MonthlyPointsCount, and the values in the DailyPointsCount column zeroed, to be filled with accumulated values daily during the new month. During that new month the builders with non-zero values in the MonthlyPointsCount column could be compensated with their own ads placed on the chart on a randomized basis with frequencies based on the relative size of their point court relative to others. Examples of hypothetical builder ads are shown in FIG. 5, to the left and below the bubble chart. Hypothetical examples illustrate the method. In the first month, assume Risk is the only builder populating the chart. Risk's ad is not shown because the method operates prospectively. During the second month Risk's ad is shown continuously, but other builders add court reporters. At the end of the second month Risk has originated 20% of the court reporters, resulting in its having 20 points during the third month. Risk's ad is shown 20% of the time. If a total of five ads are presented on the chart as shown in FIG. 5, each one would have its own probability of presentation, based on randomized random percentages. That is, Risk's ad would have a 20% chance of being presented every time a lawyer requested a view of the court reporter chart. Such a randomized system would save the overhead of keeping accurate track of presentation counts and matching them with point values. However, an alternative embodiment could build a tracking system so builder point values corresponded precisely with number of ad presentations. In yet another embodiment, point values could be compensated in any other way.

Embodiment: Combining offers. In one embodiment, the software application enables combination of a plurality of charts representing individual products or services into a single chart. For instance, a supermarket advertiser can create a combined ‘market basket for family of four for the week’ chart, with each component of the chart comprising separate charts, such a s charts for two half gallons of 2% milk, a pound of strawberries, a dozen eggs, and a loaf of wheat bread. Thus, component advertisers can have advertisements listed in each of the component charts (i.e., a ‘half gallon of 2% milk’ chart) and in the combined chart (i.e. the ‘market basket for family of four for the week’ chart). As the component advertisers update prices or run specials in the component charts, these changes are also reflected in the combined chart. Accordingly, the software application allows consumers to find the best prices for a combination of goods or services, such as their weekly food needs.

Embodiment: Consumers rankings. In alternate embodiments, a chart created through a private chart embodiment can have several metrics to evaluate chart advertisers. The software application enables consumers to create a customized aggregate metric with weighted combinations of the several metrics. For example, an institutional food consumer who seeks advertisers who grow their food consistent with sustainability and low carbon use may create a chart with a host of metrics related to sustainability and carbon footprints. Assume there are ten metrics, A, B, C, . . . J, each with a continuous, discrete, or binary ranges. The software application enables consumers, through use of sliders or any other convenient means, to weight each of these metrics as desired. For instance, metric A can be weighted 30%, metric B can be weighted 90%, and so on, so that a customized aggregate metric is created for the consumer equal to 0.3×A+0.9×B . . . . The software application then provides summary data using the customized aggregate metric, such as a graph of the customized aggregate metric against price, for the advertisers listed within the chart. Likewise, a different consumer can use the same underlying metrics to create a different customized aggregate metric.

Embodiment: Validating advertiser information. In a related embodiment, the software application provides age validation to protect against age fraud. Advertisers who desire to validate their age can do so by using a validator as discussed infra. In another particular embodiment, the software application provides age blurring to protect against identity theft. To do so, the software application subtracts the system date from date of birth (expressed in days), adds a random number, and then converts the result to years. Consumers are then presented with this number, which is a reasonably accurate statement of age, without revealing the actual date of birth of the advertiser.

In yet a further embodiment, the software application provides a method for validating advertiser assertions by obtaining validation by trusted third parties referred to as validators. Once validated, the assertions bear notice that the assertions has been validated, by whom, and when. Modification of the validated assertion would result in the validation notice being removed, but modified assertions can be re-validated. For instance, an advertiser that indicates he holds a masters in business administration from a named university may or may not be lying and a consumer may need to know the truth. A validator can validate this assertion and the assertion would thereafter bear a notice of validation for consumers to review. The software application permits existing validators to validate the credentials of those seeking to become validators. Furthermore, the software application provides creation of charts for validators to list advertisements for their services.

Embodiment: Null search results. In yet a further embodiment, when a consumer searches for a chart or advertisement within a given geographic area and no results are produced, the software application presents the closest matches from business directory listings. Alternatively, the software application invites the consumer to create a private chart for submission to businesses within the business directory listings, to businesses via specified email addresses, or to advertisers of advertisements containing similar keywords.

Embodiment: Governance. In an additional embodiment, the advertiser that creates a new chart becomes the ‘manager’ of the chart. The chart manager is able to poll chart advertisers for approval to change chart configurations, such as keywords, chart names, pricing models, and visual appearance. Furthermore, the chart manager is able to assess chart advertisers for purposes of promoting the chart, thereby giving chart managers the ability to achieve trade association functionality at a fraction of the cost of freestanding trade associations. And, chart managers also oversee chart recruitment, training, promotion, and governance. The chart manager may or may not be compensated. In various other embodiments, groups of chart advertisers can agree to joint management of charts.

Embodiment: Distance adjustments. In alternate embodiments, the software application provides price adjustments for any chart selling any product. The price adjustments can be based upon time, distance, or features whenever these factors occur inconsistently between advertisers so that a standardized price is available for consumers. The software application provides these cost adjustments in the summary data for the chart. For example, gas prices are high and gas stations compete by pricing their gas competitively. While price is important, the cost of driving to a distant gas station advertiser location can be factored in to the price to more accurately determine which of two gas station advertisers offers a better price. Thus, when considering an ‘unleaded gasoline 87 octane, per gallon’ chart, the software application permits a consumer to input a geographic location and vehicle gas mileage to compensate for the cost of driving to various gas station advertiser locations. As another example, some hotels charge for internet access and others do not. Thus, when considering a ‘hotel overnight stay, per night’ chart, the software application factors in various features so that a consumer guest desiring internet access can determine which hotel truly offers the best value.

Embodiment: Personals. In yet an additional embodiment, the software application provides for charts having non-financial offers whereby consumers accept with non-financial means. For instance, the software application enables love charts where love advertisers advertise their offer for romance and where the requested acceptance includes conditions for acceptance of romance. Thus, a love advertiser in a ‘never-married men seeking women for romance and the potential of marriage and kids’ chart involves an offer by the love advertiser to spend time with those accepting the offer, a representation that he has never been married, and that he is interested in having kids. The software application likewise enables love charts with other variations, such as romance where kids were excluded from future plans.

Embodiment: Complementary offers. In one embodiment, a consumer who is not satisfied with the prices listed in a chart can list a complementary offer in the same chart by listing the price they would offer for the chart's service. The software application enables chart advertisers to be notified whenever a complementary offer is posted, which may be filtered based upon the level of the price. Once an advertisement is listed meeting the complementary offer, the consumer is contacted and notified of such.

Embodiment: Rating offers. In a further embodiment, the software application provides a method for serving up relevant charts and advertisements and also marginalizing incomplete or maliciously written charts and advertisements. The method can consider the completeness of charts or advertisements, the number of advertisements contained within a chart, and any other similar factor when serving up the charts and advertisements.

Embodiment: Managing offers. In yet another embodiment, the software application enables an advertiser to collectively and easily manage advertisements listed in a plurality of charts. For instance, the advertiser can turn off advertisements in certain charts, such as when the advertiser goes on vacation or becomes too busy to accept new work. Such advertisements can still be present in an advertiser's profile, such as to indicate an area of expertise, and can be turned on at will.

While preferred and alternate embodiments of the invention have been illustrated and described, as noted above, many changes can be made without departing from the spirit and scope of the invention. Accordingly, the scope of the invention is not limited by the disclosure of these preferred and alternate embodiments.

What is claimed is:

1. A computer implemented software application, the software application configured to performing the operations comprising:
providing a framework to accept one or more customized definitions of one or more products or services needed by one or more consumers;
receiving a customized definition of a product or service;
publishing the customized definition of a product or service to one or more advertisers;
accepting one or more offers to provide the product or service from the one or more advertisers; and
publishing the one or more offers to the one or more consumers in a graphical format.
